(19) United States
(12) Patent Application Publication
(10) Pub. No.: US 2025/0203549 A1
(43) Pub. Date: Jun. 19, 2025

(54) Maintenance of Multiple TA in the Same Serving Cell for Multi-TRP Operation

(71) Applicant: Apple Inc., CUPERTINO, CA (US)

(72) Inventors: Haitong SUN, Saratoga, CA (US); Chunxuan YE, San Diego, CA (US); Dawei ZHANG, Saratoga, CA (US); Hong HE, San Jose, CA (US); Jie CUI, San Jose, CA (US); Wei ZENG, Saratoga, CA (US); Yushu ZHANG, Beijing (CN)

(21) Appl. No.: 18/845,582

(22) PCT Filed: Mar. 10, 2022
(86) PCT No.: PCT/CN2022/080241

§ 371 Date: Sep. 10, 2024

(51) Int. Cl. H04W 56/00; H04W 74/0833

(52) U.S. Cl. CPC H04W 56/0045; H04W 74/0833

(57) ABSTRACT

A user equipment (UE) is configured to receive, from a serving base station of a radio access network, an uplink (UL) timing advance configuration including a first time alignment timer (TAT) corresponding to a first transmission and reception point (TRP) and a second TAT corresponding to a second TRP in a multi-TRP network arrangement, detect an out of synchronization (OOS) condition for the first TRP based on the first TAT while the second TRP remains synchronized based on the second TAT, or receive a physical downlink control channel (PDCCH) order from the network mapped to the first TRP triggering a physical random access channel (PRACH) transmission, stop UL transmissions for at least the first TRP and transmit the PRACH so that the network can determine and configure a new TAT for the first TRP.

### TECHNICAL FIELD

The present disclosure generally relates to maintenance of multiple TA in the same serving cell for multi-TRP operation.

### BACKGROUND

Multiple transmission and reception point (multi-TRP) functionality in 5G New Radio (NR) involves a UE maintaining multiple radio links with multiple TRPs (e.g., multiple gNBs or multiple cells under the control of a single gNB) simultaneously on the same carrier. In some scenarios, e.g., when a timing synchronization error exists between two TRPs or when the distance between two TRPs is large, the UE can fall out of synchronization (OOS) with one or more of the TRPs.

### SUMMARY

Some exemplary embodiments are related to a processor of a user equipment (UE) configured to receive, from a serving base station of a radio access network, an uplink (UL) timing advance configuration including a first time alignment timer (TAT) corresponding to a first transmission and reception point (TRP) and a second TAT corresponding to a second TRP in a multi-TRP network arrangement, detect an out of synchronization (OOS) condition for the first TRP based on the first TAT while the second TRP remains synchronized based on the second TAT, or receive a physical downlink control channel (PDCCH) order from the network mapped to the first TRP triggering a physical random access channel (PRACH) transmission, stop UL transmissions for at least the first TRP and transmit the PRACH so that the network can determine and configure a new TAT for the first TRP.

Other exemplary embodiments are related to a user equipment (UE) having a transceiver configured to communicate with a first transmission and reception point (TRP) and a second TRP in a multi-TRP network arrangement and a processor communicatively coupled to the transceiver and configured to receive, from a serving base station of a radio access network, an uplink (UL) timing advance configuration including a first time alignment timer (TAT) corresponding to the first TRP and a second TAT corresponding to the second TRP, detect an out of synchronization (OOS) condition for the first TRP based on the first TAT while the second TRP remains synchronized based on the second TAT, or receive a physical downlink control channel (PDCCH) order from the network mapped to the first TRP triggering a physical random access channel (PRACH) transmission, stop UL transmissions for at least the first TRP and transmit the PRACH so that the network can determine and configure a new TAT for the first TRP.

Further exemplary embodiments are related to a processor of a base station configured with a first transmission and reception point (TRP) and a second TRP in a multi-TRP network arrangement, wherein the processor is configured to: transmit, to a user equipment (UE), an uplink (UL) timing advance configuration including a first time alignment timer (TAT) corresponding to the first TRP and a second TAT corresponding to the second TRP, detect an out of synchronization (OOS) condition for the first TRP while the second TRP remains synchronized, in response to detecting the OOS condition, transmit a physical downlink control channel (PDCCH) order, mapped to the first TRP, that triggers a UE physical random access channel (PRACH) transmission, receive the UE PRACH transmission, determine a new timing advance (TA) based on a time delay from the UE PRACH transmission and transmit, to the UE, a new timing advance configuration including the new TA.

Additional exemplary embodiments are related to a base station having a first transmission and reception point (TRP), a second TRP in a multi-TRP network arrangement, and a processor communicatively coupled to the first TRP and the second TRP wherein the processor is configured to transmit, to a user equipment (UE), an uplink (UL) timing advance configuration including a first time alignment timer (TAT) corresponding to the first TRP and a second TAT corresponding to the second TRP, detect an out of synchronization (OOS) condition for the first TRP while the second TRP remains synchronized, in response to detecting the OOS condition, transmit a physical downlink control channel (PDCCH) order, mapped to the first TRP, that triggers a UE physical random access channel (PRACH) transmission, receive the UE PRACH transmission, determine a new timing advance (TA) based on a time delay from the UE PRACH transmission and transmit, to the UE, a new timing advance configuration including the new TA.

Other exemplary embodiments are related to a processor of a user equipment (UE) configured to receive, from a serving base station of a network, an uplink (UL) timing advance configuration including a single time alignment timer (TAT) corresponding to a first transmission and reception point (TRP) and a second TRP in a multi-TRP network arrangement, detect an out of synchronization (OOS) condition for either the first TRP or the second TRP based on the TAT, or receive a physical downlink control channel (PDCCH) order from the network triggering at least one physical random access channel (PRACH) transmission, stop UL transmissions for both the first and second TRPs and transmit the at least one PRACH to at least one of the first and second TRPs.

Still further exemplary embodiments are related to a processor of a base station configured with a first transmission and reception point (TRP) and a second TRP in a multi-TRP network arrangement, wherein the processor of the base station is configured to transmit, to a user equipment (UE), an uplink (UL) timing advance configuration including a single time alignment timer (TAT) corresponding to the first TRP and a second TAT corresponding to the second TRP, detect an out of synchronization (OOS) condition for either the first TRP or the second TRP and in response to detecting the OOS condition, transmit a physical downlink control channel (PDCCH) order triggering at least one UE physical random access channel (PRACH) transmission.

### BRIEF DESCRIPTION OF THE DRAWINGS

FIG. 1 shows an exemplary network arrangement according to various exemplary embodiments.

FIG. 2 shows an example of multiple transmission and reception points (TRPs) deployed at different locations according to various exemplary embodiments.

FIG. 3 shows an exemplary user equipment (UE) according to various exemplary embodiments.

FIG. 4 shows an exemplary base station according to various exemplary embodiments.

FIG. 5a shows an exemplary network arrangement for multi-TRP operation where a first TRP (TRP1) is located closer to a UE than a second TRP (TRP2) according to various exemplary embodiments.

FIG. 5b shows an exemplary diagram for a propagation delay of an uplink (UL) transmission in the multi-TRP operation of FIG. 5a according to various exemplary embodiments.

FIG. 6a shows an exemplary network arrangement for multi-TRP operation where a first TRP (TRP1) is not OOS for a UE 605 and a second TRP (TRP2) is OOS for the UE according to various exemplary embodiments.

FIG. 6b shows an exemplary diagram for dropping UL transmissions in the multi-TRP operation of FIG. 6a when only one TRP (e.g., TRP2) is OOS according to various exemplary embodiments.

FIG. 7 shows an exemplary diagram for UL transmissions in a multi-TRP operation where multiple UL transmissions overlap in the time domain according to various exemplary embodiments.

FIG. 8 shows an exemplary diagram for downlink (DL) transmissions in a multi-TRP operation where multiple DL transmissions are received at a UE with a reception timing difference (RTD) greater than the cyclic prefix (CP) according to various exemplary embodiments.

FIG. 9 shows a method for maintaining multiple timing advances (TA) in the same serving cell for multi-TRP operation according to various exemplary embodiments.

### DETAILED DESCRIPTION

The exemplary embodiments may be further understood with reference to the following description and the related appended drawings, wherein like elements are provided with the same reference numerals. The exemplary embodiments relate to timing alignment (TA) operations for a user equipment (UE) in a multiple transmission and reception point (multi-TRP) arrangement in a 5G New Radio (NR) network. In particular, some exemplary embodiments relate to the maintenance of multiple time alignment timers (TAT) per serving cell, wherein a separate TAT is maintained for each TRP. In addition, other exemplary embodiments are related to operations for multi-TRP operation when only a single TAT is maintained per serving cell.

In some aspects, UE behavior is described for scenarios when OOS is declared for one or more of the TRPs in the multi-TRP arrangement. For example, the UE can transmit a physical random access channel (PRACH) to one or more of the TRPs, as will be described below. In other aspects, the UE can receive one or more PDCCH orders from the one or more TRPs to trigger the transmission of one or more PRACHs.

In still other aspects, UE behavior is described for uplink (UL) transmission conflicts or downlink (DL) reception conflicts that can result from the use of multiple TATs.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any appropriate electronic component.

The exemplary embodiments are also described with regard to a 5G New Radio (NR) network. However, reference to a 5G NR network is merely provided for illustrative purposes. The exemplary embodiments may be utilized with any network that utilizes beamforming. Therefore, the 5G NR network as described herein may represent any type of network that implements beamforming.

In addition, the exemplary embodiments are described with regard to a next generation node B (gNB) that is configured with multiple TRPs. Throughout this description, a TRP generally refers to a set of components configured to communicate with a UE. In some embodiments, multiple TRPs may be deployed locally at the gNB. For example, the gNB may include multiple antenna arrays/panels that are each configured to generate a different beam. In other embodiments, multiple TRPs may be deployed at various different physical locations and are connected to the gNB via a backhaul connection. For example, multiple small cells may be deployed at different physical locations and connected via backhaul links to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to communicate with a UE.

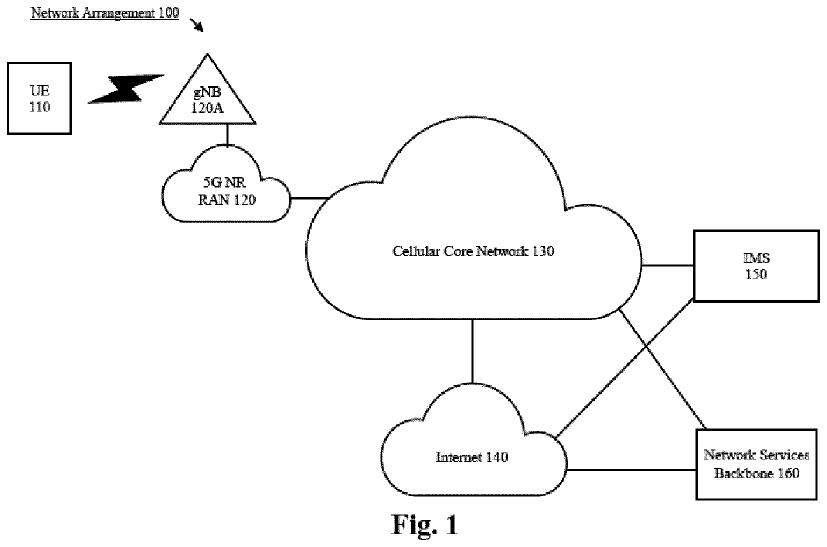

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution RAN, a legacy cellular network, a WLAN, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In network arrangement 100, the 5G NR RAN 120 includes a base station (e.g., gNB 120A) that represents a gNB that is configured with multiple TRPs. Each TRP may represent one or more components configured to transmit and/or receive a beam. In some embodiments, multiple TRPs may be deployed locally at the gNB 120A. In other embodiments, multiple TRPs may be distributed at different locations and connected to the gNB.

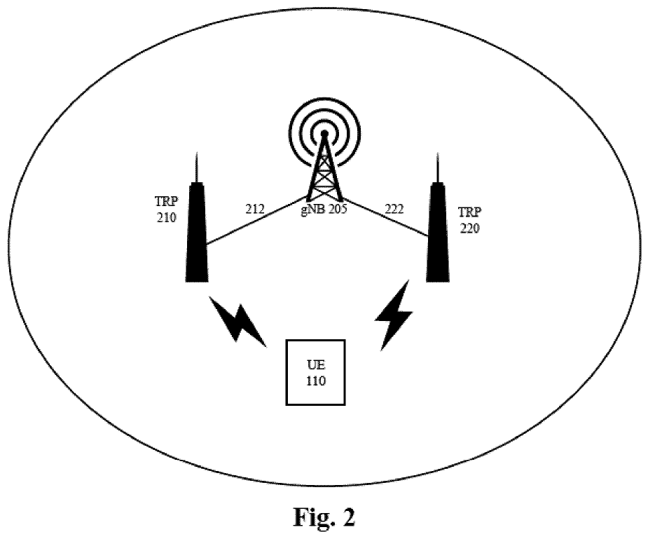

FIG. 2 shows an example of multiple TRPs deployed at different locations. In this example, the gNB 205 is configured with a first TRP 210 via a backhaul connection 212 and a second TRP 220 via backhaul connection 222. Each of the TRPs 210, 220 may perform communications with the UE 110. However, the gNB 205 may be configured to control the TRPs 210, 220 and perform operations such as, but not limited to, assigning resources, configuring group pairs, configuring reporting restrictions, implementing beam management techniques, etc.

The example shown in FIG. 2 is not intended to limit the exemplary embodiments in any way. Those skilled in the art will understand that 5G NR TRPs are adaptable to a wide variety of different conditions and deployment scenarios. An actual network arrangement may include any number of different types of base stations, cells and/or TRPs being deployed by any number of RANs in any appropriate arrangement. Thus, the example of a single gNB 120A in FIG. 1 and a single gNB 205 with two TRPs 210, 220 in FIG. 2 is merely provided for illustrative purposes.

The UE 110 may connect to the 5G NR-RAN 120 via the qNB 120A. Those skilled in the art will understand that any association procedure may be performed for the UE 110 to connect to the 5G NR-RAN 120. For example, as discussed above, the 5G NR-RAN 120 may be associated with a particular cellular provider where the UE 110 and/or the user thereof has a contract and credential information (e.g., stored on a SIM card). Upon detecting the presence of the 5G NR-RAN 120, the UE 110 may transmit the corresponding credential information to associate with the 5G NR-RAN 120. More specifically, the UE 110 may associate with a specific cell (e.g., the gNB 120A). However, as mentioned above, reference to the 5G NR-RAN 120 is merely for illustrative purposes and any appropriate type of RAN may be used.

In addition to the 5G NR RAN 120, the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

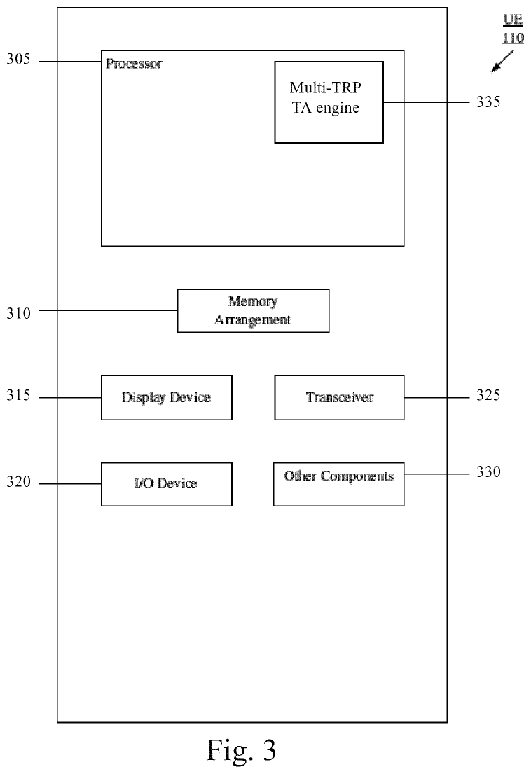

FIG. 3 shows an exemplary UE 110 according to various exemplary embodiments. The UE 110 will be described with regard to the network arrangement 100 of FIG. 1. The UE 110 may include a processor 305, a memory arrangement 310, a display device 315, an input/output (I/O) device 320, a transceiver 325 and other components 330. The other components 330 may include, for example, an audio input device, an audio output device, a power supply, a data acquisition device, ports to electrically connect the UE 110 to other electronic devices, etc.

The processor 305 may be configured to execute a plurality of engines of the UE 110. For example, the engines may include a multi-TRP timing alignment (TA) engine 335. The multi-TRP TA engine 335 can be configured to perform operations related to receiving a time alignment timer (TAT) configuration for one or more TATs corresponding to one or more TRPs in a multi-TRP arrangement. The multi-TRP TA engine 335 can perform TA operations including but not limited to: starting or restarting a TAT in response to a TA command from one or more TRPs; detecting an OOS condition for one or more TRPs, independently or jointly; receiving a PDCCH order from one or more TRPs; transmitting PRACH to one or more TRPs when OOS is declared or the PDCCH order is received; and performing UL/DL transmission conflict resolution operations when multiple TAT cause UL transmissions to overlap in time or cause DL transmissions to overlap in time. These operations and additional operations will be described in greater detail below.

The above referenced engine being an application (e.g., a program) executed by the processor 305 is only exemplary. The functionality associated with the engine may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 305 is split among two or more processors such as a baseband processor and an applications processor. The exemplary embodiments may be implemented in any of these or other configurations of a UE.

The memory arrangement 310 may be a hardware component configured to store data related to operations performed by the UE 110. The display device 315 may be a hardware component configured to show data to a user while the I/O device 320 may be a hardware component that enables the user to enter inputs. The display device 315 and the I/O device 320 may be separate components or integrated together such as a touchscreen. The transceiver 325 may be a hardware component configured to establish a connection with the 5G NR-RAN 120, an LTE-RAN (not pictured), a legacy RAN (not pictured), a WLAN (not pictured), etc. Accordingly, the transceiver 325 may operate on a variety of different frequencies or channels (e.g., set of consecutive frequencies).

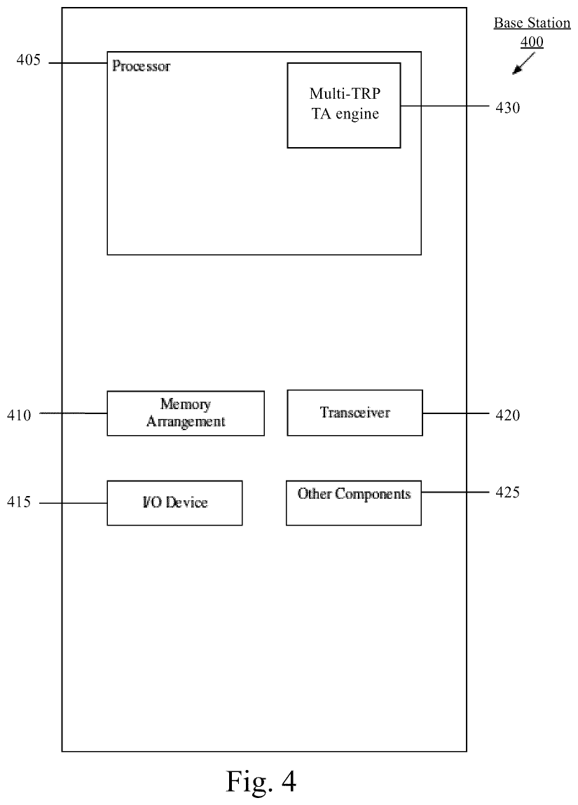

FIG. 4 shows an exemplary base station 400 according to various exemplary embodiments. The base station 400 may represent the gNB 120A, the gNB 205 or any other access node through which the UE 110 may establish a connection and manage network operations.

The base station 400 may include a processor 405, a memory arrangement 410, an input/output (I/O) device 415, a transceiver 420 and other components 425. The other components 425 may include, for example, an audio input device, an audio output device, a battery, a data acquisition device, ports to electrically connect the base station 400 to other electronic devices, one or more transmission reception points (TRPs), etc.

The processor 405 may be configured to execute a plurality of engines for the base station 400. For example, the engines may include multi-TRP timing alignment (TA) engine 430. The multi-TRP TA engine 430 can be configured to perform operations related to transmitting a time alignment timer (TAT) configuration to a UE for one or more TATs corresponding to one or more TRPs in a multi-TRP arrangement. The multi-TRP TA engine 430 can perform TA operations including but not limited to: detecting an OOS condition for one or more TRPs, independently or jointly; transmitting a PDCCH order from one or more TRPs to the UE; and receiving PRACH at one or more TRPs. These operations and additional operations will be described in greater detail below. It should be understood that certain processing steps described for the multi-TRP TA engine 430 can be implemented directly at the base station 400 or may be implemented at one or more TRPs under the control of the base station 400. Thus, the functionality described for the multi-TRP timing alignment (TA) engine 430 can be performed at the base station 400, at associated TRPs, e.g., TRPs 210 and 220, or in combination between the base station 400 and the TRPs.

The above noted engine 430 each being an application (e.g., a program) executed by the processor 405 is only exemplary. The functionality associated with the engine 430 may also be represented as a separate incorporated component of the base station 400 or may be a modular component coupled to the base station 400, e.g., an integrated circuit with or without firmware. For example, the integrated circuit may include input circuitry to receive signals and processing circuitry to process the signals and other information. In addition, in some base stations, the functionality described for the processor 405 is split among a plurality of processors (e.g., a baseband processor, an applications processor, etc.). The exemplary embodiments may be implemented in any of these or other configurations of a base station.

The memory 410 may be a hardware component configured to store data related to operations performed by the base station 400. The I/O device 415 may be a hardware component or ports that enable a user to interact with the base station 400. The transceiver 420 may be a hardware component configured to exchange data with the UE 110 and any other UE in the network arrangement 100. The transceiver 420 may operate on a variety of different frequencies or channels (e.g., set of consecutive frequencies). Therefore, the transceiver 420 may include one or more components (e.g., radios) to enable the data exchange with the various networks and UEs.

Multiple transmission and reception point (multi-TRP) functionality in 5G New Radio (NR) involves a UE maintaining multiple radio links with multiple TRPs (e.g., multiple gNBs or multiple cells under the control of a single gNB) simultaneously on the same carrier. In some scenarios, as described above, a single serving cell can control multiple TRPs via backhaul links. However, if the TRPs are separated by a large distance, or if a timing synchronization issue exists between the TRPs, then the UE can detect a synchronization error even when the network, the UE and respective TRPs are synchronized from the gNB point of view.

The time alignment timer (TAT) (timeAlignmentTimer) operation is specified in TS 38.321 clause 5.2. The time alignment timer is specified per timing advance group (TAG). The timing advance group refers to a group of cells configured by radio resource control (RRC) that use a same timing reference cell and a same timing advance value. The TAT controls how long the UE considers the cells belonging to the associated TAG to be uplink time aligned (synchronized).

In current releases of NR, the UE keeps track of whether the UE is out of sync (OOS) on the UL, i.e., whether the configured TA is still valid or not, using the TAT. In principle, the UE starts or restarts the TAT when the UE receives a valid TA command. The TA command can be transmitted to the UE via a medium access control (MAC) control element (MAC-CE) or a random access response (RAR). The UE is considered to be OOS when the TAT expires or if the TAT is not running (e.g., when the TAT is first configured or has been stopped). When the OOS condition is declared, the UE stops any UL operation except RACH operation.

When UE is OOS on the UL, for mobile originated (MO) data, the UE transmits a PRACH to acquire UL timing before any other UL operations. For mobile terminated (MT) data, the network can use a Physical Downlink Control Channel (PDCCH) order to trigger the UE to transmit a PRACH to acquire UL timing before any other DL/UL operation. The PDCCH order can be a Downlink Control Information (DCI) format 1_0 comprising fields for a random access preamble index, a UL/SUL indicator, a SS/PBCH index and a PRACH Mask index. When the OOS condition is detected, e.g., by the expiration of the TAT, the UE flushes all HARQ buffers for all serving cells, notifies RRC to release UL grants, etc., until a new TA is received. The UE will not perform any UL transmission on a serving cell except the random access (PRACH) preamble and MSGA.

The UE sends a PRACH preamble as the first message from the UE to a base station when establishing initial access. In a contention-based random access (CBRA) procedure, the UE transmits the PRACH preamble (e.g., Msg1) with a preamble signature randomly selected by the UE from a pool of preambles shared with other UEs in the cell. In a contention-free RA (CFRA) procedure, the UE uses a dedicated preamble provided by the network specifically for the UE via, for example, RRC signaling or DCI on the PDCCH. In either procedure, the network responds to the detected RACH preamble (i.e., Msg1) with a random access response (RAR) (e.g., Msg2) on physical downlink shared channel (PDSCH) that is scheduled by a PDCCH and includes a resource allocation for a subsequent physical uplink shared channel (PUSCH) transmission by the UE (e.g., Msg3). In CBRA, the network performs a contention resolution procedure and transmits Msg4 based on a UE identifier in the detected Msg3 PUSCH. Repetition techniques may be used by the base station for Msg2 and Msg4 for coverage enhancement (CE).

The design for communication channels between a UE and a TRP (e.g., PDSCH, PDCCH, PUCCH, PUSCH) assumes that different TRPs are synchronized at the UE receiver. The UE and the network cell are considered synchronized when the Maximum Receive Timing Difference (MRTD) is less than the cyclic prefix (CP). In practice, it is possible that, from the UE receiver point of view, the MRTD between different TRPs is more than CP. For example, a timing synchronization error can exist between two TRPs, or the distance between different panels or different TRPs can be large.

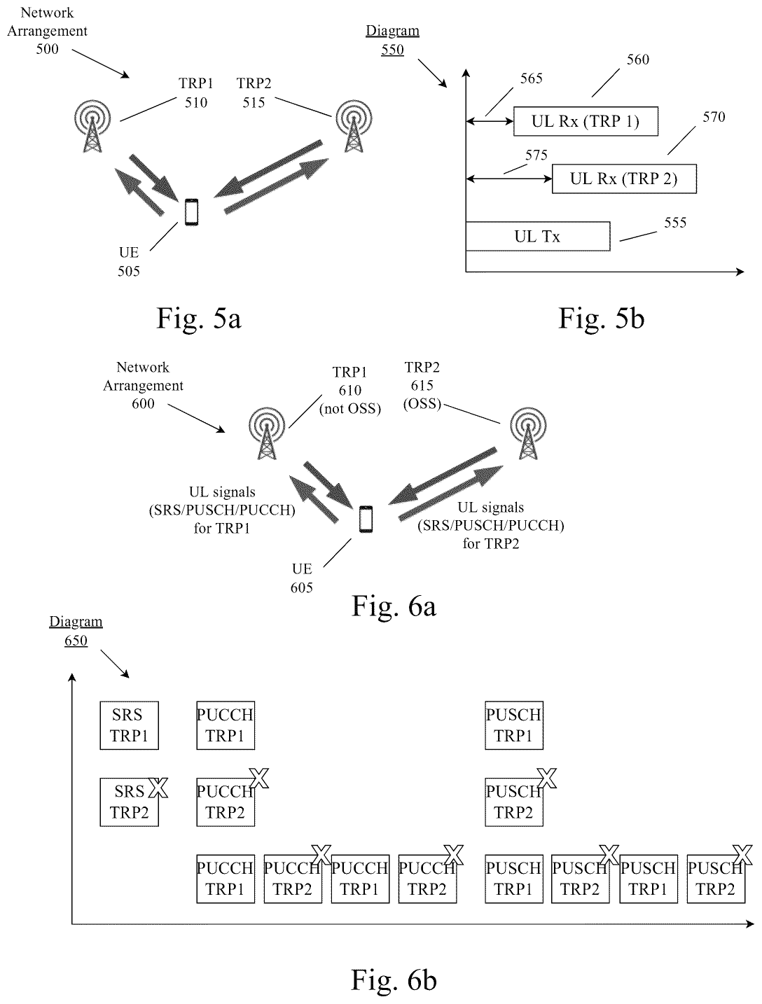

FIG. 5a shows an exemplary network arrangement 500 for multi-TRP operation where a first TRP (TRP1) 510 is located closer to a UE 505 than a second TRP (TRP2) 515. FIG. 5b shows an exemplary diagram 550 for a propagation delay of a UL transmission in the multi-TRP operation of FIG. 5a. In this example, the UL transmission 555 is received 560 at TRP1 510 after a first propagation delay 565 and is received 570 at TRP2 515 after a second propagation delay 575. In this example, the second propagation delay 575 has an MRTD that is greater than CP, thus causing an OOS condition.

To address this synchronization issue, timing alignment (TA) operations can be specified for UL multi-DCI multi-TRP operation. In the following, reference is made to two TRPs and corresponding synchronization operations. However, it should be understood that the exemplary embodiments described herein can be extended to any number of TRPs.

According to various exemplary embodiments, operations are described for multiple timing alignments (TA) in multi-TRP operation. In one embodiment, time alignment timer (TAT) (timeAlignmentTimer) operations for multi-TRP operation are described. In one aspect, one TAT is used, while in other aspects, multiple TATs are used, each corresponding to a different TRP. In another embodiment, PDCCH order operations for multi-TRP operation are described. In still other aspects, UL transmission and DL reception conflict handling operations are described.

According to one aspect of the exemplary embodiments, time alignment timer (TAT) (timeAlignmentTimer) operations are described to provide support for multi-TRP operation. In one option, a single TAT is maintained per serving cell, corresponding to both TRPs. In another option, two TATs are maintained per serving cell, corresponding to two different TRPs.

When a single TAT is maintained at the UE per serving cell, the TAT operation can be performed based on the TA command and/or PRACH operation from either TRP. In one aspect, if the UE receives a TA command from either TRP, the UE will start or restart the single TAT. In another aspect, the UE PRACH operation to either TRP will cause the timeAlignmentTimer to run or stop.

The UE initiates the PRACH operation if it is determined that the UE is OOS. The UE is considered OOS when the TAT expires, or if the TAT is not running. When the UE is OOS with the single TAT, to transmit MO data, the UE triggers and transmits the PRACH. The UE receives a new TA and can subsequently transmit on the UL. In one option, the UE triggers and transmits the PRACH to both TRPs. In another option, the UE triggers and transmits the PRACH to only one TRP.

According to another aspect of the exemplary embodiments, when two TATs are maintained per serving cell, one or multiple TATs can be maintained per timing advance group (TAG). In one option, a single TAT is maintained per TAG. Multiple TAGS, e.g., up to two TAGS, can be configured per serving cell, wherein different TRPs are assigned with different TAGs. Thus, a TAT is maintained per TRP.

In another option, when two TATs are maintained per serving cell, up to two TATs can be maintained per TAG, wherein two TRPs are assigned with same the TAG and the different TATs correspond to different TRPs. In each TAG, separate indications can be used to map two different TAs in the same TAG. For example, the indication can comprise a closed loop power control index, a CORESETPoolindex, etc.

In another aspect, when two TATs are maintained per serving cell, the UE can declare OOS for each TRP separately, depending on the TAT corresponding to the TRP. When the UE is OOS for a particular TRP, to transmit MO data, the UE triggers and transmits PRACH to the corresponding TRP only.

When OOS is declared separately for each TRP, as described above, if one TRP is OOS but the other TRP is not OOS, then the following options are available. In a first option, the UE stops UL operation (e.g., PUSCH, PUCCH, or SRS operation) only to the corresponding TRP for which the UE declares OOS. For SRS/PUCCH/PUSCH operations without multi-TRP repetition, the operations are stopped to the OOS TRP. For PUCCH/PUSCH operations with multi-TRP repetition, the PUCCH/PUSCH repetitions are stopped to the OOS TRP.

FIG. 6a shows an exemplary network arrangement 600 for multi-TRP operation where a first TRP (TRP1) 610 is not OOS for a UE 605 and a second TRP (TRP2) 615 is OOS for the UE 605. In this example, the UE 605 is configured for transmitting UL signals (SRS/PUSCH/PUCCH) to both TRP1 610 and TRP2 615 and multi-TRP repetition is enabled for PUCCH/PUSCH. FIG. 6b shows an exemplary diagram 650 for dropping UL transmissions in the multi-TRP operation of FIG. 6a when only one TRP (e.g., TRP2 615) is OOS. In this example, according to the first option discussed above, the SRS and the corresponding PUCCH/PUSCH for TRP2 615 are dropped and the PUCCH/PUSCH repetitions for TRP2 615 are dropped when TRP2 615 is OOS to the UE 605. The SRS and the corresponding PUCCH/PUSCH for TRP1 610 are not dropped and the PUCCH/PUSCH repetitions for TRP1 610 are not dropped when TRP1 610 is not OOS to the UE 605.

In another option, the UE stops UL operation (e.g., PUSCH, PUCCH, or SRS operation) completely to both TRPs.

According to another aspect of the exemplary embodiments, PDCCH order operations are described for multi-TRP operation. The network can detect the OOS condition in various ways, for example, based on a timer (similar to the TAT for the UE), based on a UL signal/channel (e.g., where the network does not detect a configured UL signal) or in other ways. The network can transmit a PDCCH order when the OOS condition is detected or for other reasons, such as loss of coverage.

When the network detects that the UE is UL OOS, for MT data, before the network schedules DL data, the network will first signal a PDCCH order to trigger a UE PRACH transmission to update the UE with a new TA. For multi-TRP operation, the following options are available.

In a first option, the PDCCH order to trigger the UE PRACH transmission can be transmitted, independently, for each TRP. In other words, for two TRPs, two different PDCCH orders can be received by the UE, one from each TRP. The PDCCH order can be mapped to each TRP in a logical way. For example, the CORESETPoolindex used for scheduling the PDCCH can map to a particular TRP. A PDCCH from different TRPs may be carried by a CORESET having different values of a CORESETPoolindex. In another example, the “Random Access Preamble index”/“SS/PBCH index” in the PDCCH order can map to a particular TRP. In still another example, a new field can be defined in DCI 0_1. In still another example, the PDCCH order can be scrambled with a different RNTI, e.g., x-RNTI.

In a second option, the PDCCH order to trigger the UE PRACH transmission can be transmitted by either TRP, e.g., a first TRP, and be used to indicate the first TRP, the second TRP, or both TRP. The DCI 0_1 sent from either TRP can comprise one or two Random Access Preamble index, one or two SS/PBCH index, or one or two PRACH Mask Index. When one index is used, the transmitting TRP can trigger PRACH for itself or for both TRPS. If two indexes are used, the transmitting TRP can trigger PRACH for itself, the other TRP, or both TRPs.

The PDCCH order contains the information about whether one or both TRP needs the PRACH transmission, e.g., TRP 1 needs PRACH, TRP 2 needs PRACH, or both TRPs 1 and 2 need PRACH. In one option, a new DCI can be used for multi-TRP PRACH to indicate the various TRPs, while a legacy DCI can be used for single-TRP PRACH PDCCH order. In another option, a 2 bit bitmap can be used to indicate such information. In still another option, a field in the PDCCH order (Random Access Preamble index, SS/PBCH index, or PRACH Mask Index) can be set to a reserved value to indicate the TRP for which the network does not instruct the UE to transmit PRACH.

According to another aspect of the exemplary embodiments, operations for handling a UL transmission conflict in multi-TRP operation are described.

When a UE does not support simultaneous UL transmission of multiple UL, a separate TA for different TRPs as described above could cause the UL frame structures for the different TRPs to not be aligned, and for the UL transmissions to the different TRPs to overlap in the time domain from the UE perspective.

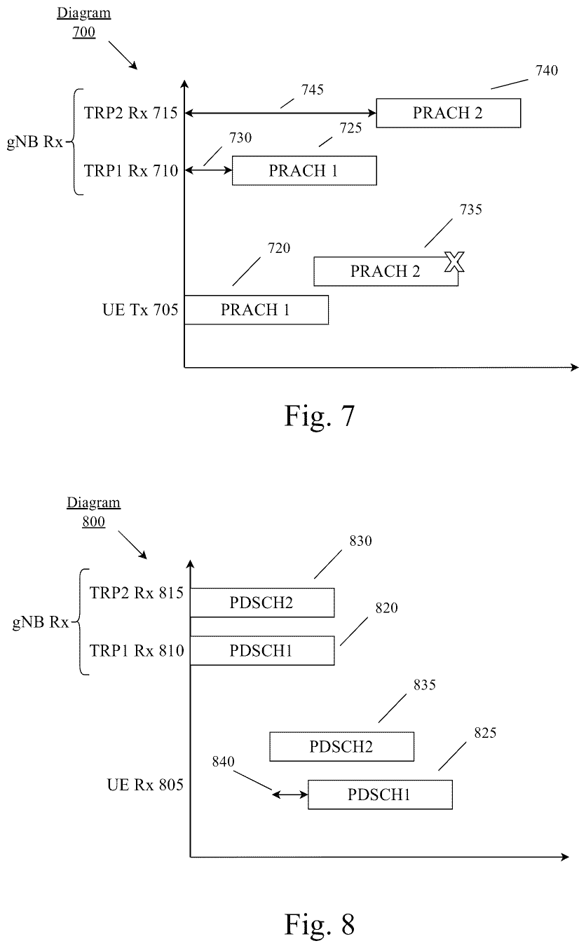

FIG. 7 shows an exemplary diagram 700 for UL transmissions in a multi-TRP operation where multiple UL transmissions overlap in the time domain. In this example, the UE 705 is scheduled to transmit a first PRACH (PRACH 1) 720 to be received 725 at TRP1 710 after a first propagation delay 730. The UE 705 is further scheduled to transmit a second PRACH (PRACH 2) 735 to be received 740 at TRP2 715 after a second propagation delay 745. In this example, the second propagation delay 745 is greater than the first propagation delay 730, and thus the TA for PRACH 2 735 is greater than the TA of PRACH 1 720, causing PRACH 1 720 and PRACH 2 735 to overlap in the time domain from the UE perspective.

When two scheduled transmissions (e.g., PUCCH, SRS, PUSCH, PRACH) are overlapped in the time domain, and the UE is not capable of simultaneous transmission, the following options may be used. In the first option, UE behavior is unspecified and the UE can drop the first PRACH 720, the second PRACH 735 or both. In the second option, the UE is permitted to drop the PRACH 2 735 transmission, as shown in FIG. 7.

According to another aspect of the exemplary embodiments, operations for handling a DL transmission conflict in multi-TRP operation are described.

When a UE does not support simultaneous DL reception of multiple DL transmissions, DL reception from the different TRPs can have a large reception timing difference exceeding the MRTD. From the network perspective, the DL transmissions from the TRPs are synchronized, while from the UE perspective, the DL receptions are out of synchronization.

FIG. 8 shows an exemplary diagram 800 for DL transmissions in a multi-TRP operation where multiple DL transmissions are received at a UE 805 with a reception timing difference (RTD) greater than CP. In this example, the network schedules a first PDSCH (PDSCH1) 820 to be transmitted from TRP1 810 and a second PDSCH (PDSCH2) 830 to be transmitted from TRP2 815. The PDSCH1 820 is received 825 at the UE 805 after a first propagation delay and the PDSCH2 830 is received 835 at the UE 805 after a second propagation delay, wherein the RTD 840 between the SSBs is greater than the CP and the PDSCH Rx are, by definition, OOS.

To address this issue, in one aspect, the UE can report the Rx timing difference between two TRPs in multi-TRP operation. The UE can report this value via, e.g., MAC-CE.

When two scheduled DL transmissions (e.g., SSB, CSI-RS, PDSCH or PDCCH) are OOS at the UE Rx, the following options may be used. In the first option, UE behavior is unspecified. In the second option, the UE is permitted to drop the first PDSCH reception 825, as shown in FIG. 8, which is scheduled for reception later in time than the second PDSCH reception 835.

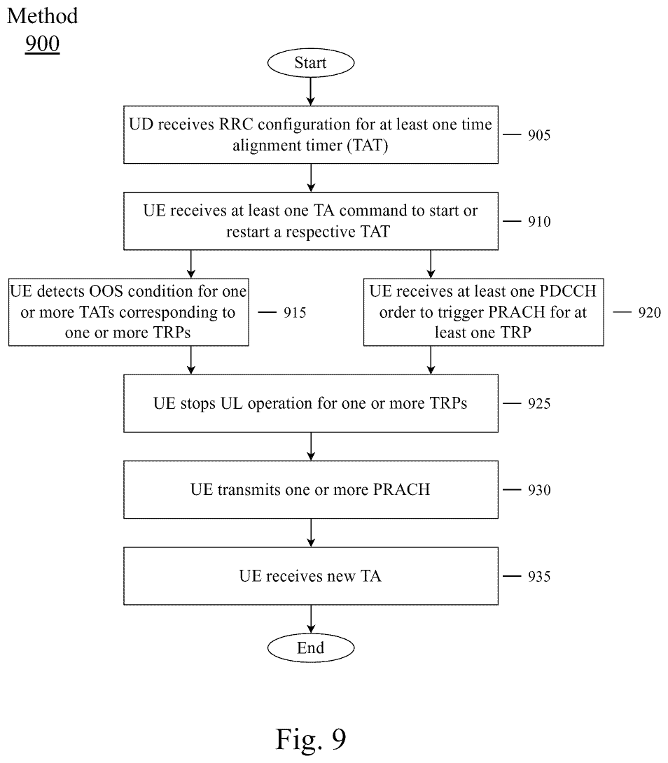

FIG. 9 shows a method 900 for maintaining multiple timing advances (TA) in the same serving cell for multi-TRP operation according to various exemplary embodiments.

In 905, the UE receives an RRC configuration for at least one time alignment timer (TAT) (timeAlignmentTimer). As described above, a single TAT can be maintained per serving cell, corresponding to multiple TRPs, or multiple TATs can be maintained per serving cell, each TAT corresponding to a different TRP (e.g., a first TAT for a first TRP and a second TAT for a second TRP). In some embodiments, multiple timing advance groups (TAG), e.g., up to two TAGS, can be configured per serving cell, and a respective TAT can be maintained per TAG. In other embodiments, multiple TATs, e.g., up to two TATs, can be maintained per TAG, wherein a first TAT corresponds to a first TRP within the TAG and a second TAT corresponds to a second TRP within the TAG.

In 910, the UE receives at least one TA command to start or restart the one or more TATs. The TA command may be in a RAR (after a UE PRACH transmission) or in a MAC CE. If a single TAT is maintained per serving cell, then the TA command will start or restart the single TAT regardless of which TRP transmitted the TA command.

If multiple TATs, e.g., two TATs, are maintained per serving cell, then a first TA command will start or restart a first TAT and a second TA will start or restart a second TAT. If multiple TAGs are assigned for multiple TRPs (e.g., a first TAG is assigned for a first TRP and a second TAG is assigned for a second TRP), a single TAT is maintained per TAG and the TA command for a particular TAG will start or restart the timer for that TAG/TRP. If multiple TATs are maintained per TAG, and multiple TRP are assigned to the same TAG, then a separate indication can be used to map the TA command to a particular TA and start or restart the corresponding TAT.

During the multi-TRP operations, the UE may be out of synchronization (OOS) with one or more of the multiple TRPs on the UL. If the UE detects the synchronization error (e.g., if the TAT is not running or if the TAT has expired), then the UE stops UL operation and transmits PRACH to acquire the UL timing for MO data, as will be explained in 915 below. If the network detects the synchronization error, then the network transmits a PDCCH order to trigger the UE to stop UL/DL operation and transmit PRACH to acquire the UL timing, as will be explained in 920 below.

In a first scenario, in 915, the UE detects the OOS condition for one or more TATs corresponding to one or more TRPs. In one example, a single TAT is maintained for the serving cell and corresponds to both TRPs. In another example, two TAT are maintained for the serving cell for respective TRPs. In this example, the first TRP can be OOS, the second TRP can be OOS, or both TRPs can be OOS. The UE can declare OOS for each TRP separately, depending on the corresponding TAT for the TRP.

In a second scenario, the network detects the OOS condition, as described above. The network can detect the OOS condition for the first TRP, the second TRP, or both TRPs and transmit one or more PDCCH orders, via either one or both TRPs, to trigger one or more UE PRACH transmissions.

In 920, the UE receives at least one PDCCH order to trigger the PRACH transmission for at least one TRP. In one option, each TRP independently transmits a PDCCH order when the respective TRP is OOS. The PDCCH order can be mapped to the transmitting TRP in a logical way based on DCI parameters. In another option, one PDCCH order transmitted from a first TRP can trigger the PRACH transmission for the first TRP, the second TRP, or both TRPs. For this option, a new DCI field or DCI format can be used.

In 925, the UE stops UL operation for one or more TRPs after either detecting the OOS condition or receiving the at least one PDCCH order. When OOS is declared (or a PDCCH order is received) for both TRPs jointly (e.g., when only a single TAT is used per serving cell), the UE stops UL operation to both TRPs. When OOS is declared separately for each TRP (e.g., when multiple TATs are used per serving cell), the UE can stop UL operation to one TRP (the OOS TRP) or both TRPs.

In 930, the UE transmits one or more PRACH. When a single TAT is maintained per serving cell corresponding to both TRPs, in one option, the UE can transmit a respective PRACH to both TRPs. In another option, the UE can transmit a single PRACH to one of the TRPs. The UE PRACH operation to either or both TRPs will cause the single TAT to run or stop.

When multiple TATs are maintained for multiple TRPs per serving cell, the UE can declare OOS (or receive a PDCCH order) for each TRP separately. For example, when the TAT for the first TRP expires, the UE transmits PRACH to the first TRP and, when the TAT for second TRP expires, the UE transmits PRACH to the second TRP.

In 935, the UE receives a new TA command including a new TA, based on the UL timing determined by the network based on the PRACH.

During multi-TRP operation with multiple TA, the UE may encounter a UL transmission conflict or a DL transmission conflict. In the UL, the separate TA can cause a first UL transmission to a first TRP and a second UL transmission to a second TRP to overlap in the time domain. When this occurs, in one option, the UE behavior can be unspecified. In another option, the UE can drop the second UL transmission (later in time than the first UL transmission). In the DL, there can be a large reception timing different (RTD) between a first DL reception from a first TRP and a second DL reception from a second TRP. When this occurs, the UE can report the RTD to the network and drop one of the DL receptions.

### EXAMPLES

In a first example, a user equipment (UE) comprises a transceiver configured to communicate with a first transmission and reception point (TRP) and a second TRP in a multi-TRP network arrangement and a processor communicatively coupled to the transceiver and configured to receive, from a serving base station of a radio access network, an uplink (UL) timing advance configuration including a first time alignment timer (TAT) corresponding to the first TRP and a second TAT corresponding to the second TRP, detect an out of synchronization (OOS) condition for the first TRP based on the first TAT while the second TRP remains synchronized based on the second TAT, or receive a physical downlink control channel (PDCCH) order from the network mapped to the first TRP triggering a physical random access channel (PRACH) transmission, stop UL transmissions for at least the first TRP and transmit the PRACH so that the network can determine and configure a new TAT for the first TRP.

In a second example, the UE of the first example, wherein the first TRP is assigned to a first timing advance group (TAG) and the second TRP is assigned to a second TAG, wherein the first TAT is maintained for the first TAG and the second TAT is maintained for the second TAG.

In a third example, the UE of the second example, wherein the UE detects the OOS condition for the first TRP and transmits the PRACH to the first TRP only.

In a fourth example, the UE of the first example, wherein the first TRP and the second TRP are assigned to a same timing advance group (TAG) and the first and second TATs are maintained in the same TAG.

In a fifth example, the UE of the fourth example, wherein the timing advance configuration indicates a parameter mapping a given TAT to the first TRP or the second TRP within the same TAG.

In a sixth example, the UE of the fifth example, wherein the parameter comprises a closed loop power control index or a CORESETPoolIndex.

In a seventh example, the UE of the first example, wherein, when the OOS condition is detected or indicated for the first TRP, the UE stops the UL transmissions for the first TRP until the new TAT is received and continues UL transmissions for the second TRP.

In an eighth example, the UE of the seventh example, wherein the UL transmissions comprise a sounding reference signal (SRS), a physical uplink control channel (PUCCH) or a physical uplink shared channel (PUSCH) without multi-TRP repetition.

In a ninth example, the UE of the seventh example, wherein the UL transmissions comprise a physical uplink control channel (PUCCH) or a physical uplink shared channel (PUSCH) with multi-TRP repetition.

In a tenth example, the UE of the first example, wherein, when the OOS condition is detected or indicated for the first TRP, the UE stops the UL transmissions for both the first TRP and the second TRP until the new TAT is received for the first TRP and a further new TAT is received for the second TRP.

In an eleventh example, the UE of the first example, wherein the UE receives the PDCCH order including a parameter mapping to the first TRP to trigger the PRACH transmission to the first TRP.

In a twelfth example, the UE of the eleventh example, wherein the parameter comprises a CORESETPoolIndex, a random access preamble index, a synchronization signal (SS) and physical broadcast channel (PBCH) index, an explicit new field in a downlink control information (DCI), or a physical downlink control channel (PDCCH) with a different scrambling sequence.

In a thirteenth example, the UE of the first example, wherein the UE receives the PDCCH order including a parameter mapping to both the first TRP and the second TRP to trigger a first PRACH transmission to the first TRP and a second PRACH transmission to the second TRP.

In a fourteenth example, the UE of the thirteenth example, wherein the parameter comprises one or two random access preamble indexes, one or two synchronization signal (SS) and physical broadcast channel (PBCH) index, or one or two PRACH mask indexes.

In a fifteenth example, the UE of the first example, wherein the UE receives the PDCCH order including a parameter mapping to either the first TRP, the second TRP, or both the first TRP and the second TRP to trigger the PRACH transmission to the first TRP, the second TRP, or both the first TRP and the second TRP.

In a sixteenth example, the UE of the fifteenth example, wherein the parameter comprises a field in a new DCI, a 2-bit bitmap, or a field in the PDCCH order being set to a reserved value.

In a seventeenth example, the UE of the first example, wherein the processor of the UE is further configured to receive a first timing advance (TA) command to start or restart the first TAT and a second timing advance command to start or restart the second TAT.

In an eighteenth example, the UE of the first example, wherein the OOS condition is detected when the first TAT expires or when the first TAT has not started.

In a nineteenth example, the UE of the first example 1, wherein the processor of the UE is further configured to determine that a first UL transmission to the first TRP and a second UL transmission to the second TRP overlap at least partially in time and drop the first UL transmission or the second UL transmission.

In a twentieth example, the UE of the first example, wherein the processor of the UE is further configured to determine that a first downlink (DL) reception from the first TRP and a second DL reception from the second TRP have a reception timing difference exceeding a maximum reception timing difference and report the reception timing difference to the network.

In a twenty first example, the UE of the twentieth example, wherein the processor of the UE is further configured to drop the first DL reception or the second DL reception.

In a twenty second example, a processor of a user equipment (UE) is configured to receive, from a serving base station of a network, an uplink (UL) timing advance configuration including a single time alignment timer (TAT) corresponding to a first transmission and reception point (TRP) and a second TRP in a multi-TRP network arrangement, detect an out of synchronization (OOS) condition for either the first TRP or the second TRP based on the TAT, or receive a physical downlink control channel (PDCCH) order from the network triggering at least one physical random access channel (PRACH) transmission, stop UL transmissions for both the first and second TRPs and transmit the at least one PRACH to at least one of the first and second TRPs.

In a twenty third example, the processor of the twenty second example, wherein the UE transmits a single PRACH to either one of the first and second TRPs.

In a twenty fourth example, the processor of the twenty second example, wherein the UE transmits a respective PRACH to both the first and second TRPs.

In a twenty fifth example, a user equipment (UE) comprises a transceiver configured to communicate with a serving base station of a network and a processor communicatively coupled to the transceiver and configured to receive, from the serving base station of the network, an uplink (UL) timing advance configuration including a single time alignment timer (TAT) corresponding to a first transmission and reception point (TRP) and a second TRP in a multi-TRP network arrangement, detect an out of synchronization (OOS) condition for either the first TRP or the second TRP based on the TAT, or receive a physical downlink control channel (PDCCH) order from the network triggering at least one physical random access channel (PRACH) transmission, stop UL transmissions for both the first and second TRPs and transmit the at least one PRACH to at least one of the first and second TRPs.

In a twenty sixth example, the UE of the twenty fifth example, wherein the UE transmits a single PRACH to either one of the first and second TRPs.

In a twenty seventh example, the UE of the twenty fifth example, wherein the UE transmits a respective PRACH to both the first and second TRPs.

In a twenty eighth example, a base station comprises a first transmission and reception point (TRP), a second TRP in a multi-TRP network arrangement, and a processor communicatively coupled to the first TRP and the second TRP wherein the processor is configured to transmit, to a user equipment (UE), an uplink (UL) timing advance configuration including a first time alignment timer (TAT) corresponding to the first TRP and a second TAT corresponding to the second TRP, detect an out of synchronization (OOS) condition for the first TRP while the second TRP remains synchronized, in response to detecting the OOS condition, transmit a physical downlink control channel (PDCCH) order, mapped to the first TRP, that triggers a UE physical random access channel (PRACH) transmission, receive the UE PRACH transmission, determine a new timing advance (TA) based on a time delay from the UE PRACH transmission and transmit, to the UE, a new timing advance configuration including the new TA.

In a twenty ninth example, the base station of the twenty eighth example, wherein the first TRP is assigned to a first timing advance group (TAG) and the second TRP is assigned to a second TAG, wherein the first TAT is maintained for the first TAG and the second TAT is maintained for the second TAG.

In a thirtieth example, the base station of the twenty ninth example, wherein the processor is further configured to receive the UE PRACH transmission at the first TRP when the OOS condition for the first TRP is detected by the UE and the UE PRACH transmission is transmitted to the first TRP only.

In a thirty first example, the base station of the twenty eighth example, wherein the first TRP and the second TRP are assigned to a same timing advance group (TAG) and the first and second TATs are maintained in the same TAG.

In a thirty second example, the base station of the thirty first example, wherein the timing advance configuration indicates a parameter mapping a given TAT to the first TRP or the second TRP within the same TAG.

In a thirty third example, the base station of the thirty second example, wherein the parameter comprises a closed loop power control index or a CORESETPoolIndex.

In a thirty fourth example, the base station of the twenty eighth example, wherein the processor of the base station is further configured to receive the UL transmissions for the second TRP while the first TRP is OOS with the UE when the UL transmissions for the first TRP are stopped until the new TAT is received.

In a thirty fifth example, the base station of the thirty fourth example, wherein the UL transmissions comprise a sounding reference signal (SRS), a physical uplink control channel (PUCCH) or a physical uplink shared channel (PUSCH) without multi-TRP repetition.

In a thirty sixth example, the base station of the thirty fourth example, wherein the UL transmissions comprise a physical uplink control channel (PUCCH) or a physical uplink shared channel (PUSCH) with multi-TRP repetition.

In a thirty seventh example, the base station of the twenty eighth example, wherein, when the OOS condition is detected or indicated for the first TRP, the UL transmissions are stopped for both the first TRP and the second TRP until the new TAT is received for the first TRP and a further new TAT is received for the second TRP.

In a thirty eighth example, the base station of the twenty eighth example, wherein the PDCCH order includes a parameter mapping to the first TRP to trigger the PRACH transmission to the first TRP.

In a thirty ninth example, the base station of the thirty eighth example, wherein the parameter comprises a CORESETPoolIndex, a random access preamble index, a synchronization signal (SS) and physical broadcast channel (PBCH) index, an explicit new field in a downlink control information (DCI), or a physical downlink control channel (PDCCH) with a different scrambling sequence.

In a fortieth example, the base station of the twenty eighth example, wherein the PDCCH order includes a parameter mapping to both the first TRP and the second TRP to trigger the PRACH transmission to the first TRP and a second PRACH transmission to the second TRP.

In a forty first example, the base station of the fortieth example, wherein the parameter comprises one or two random access preamble indexes, one or two synchronization signal (SS) and physical broadcast channel (PBCH) index, or one or two PRACH mask indexes.

In a forty second example, the base station of the twenty eighth example, wherein the PDCCH order includes a parameter mapping to either the first TRP, the second TRP, or both the first TRP and the second TRP to trigger the PRACH transmission to the first TRP, the second TRP, or both the first TRP and the second TRP.

In a forty third example, the base station of the forty second example, wherein the parameter comprises a field in a new DCI, a 2-bit bitmap, or a field in the PDCCH order being set to a reserved value.

In a forty fourth example, the base station of the twenty eighth example, wherein the processor of the base station is further configured to transmit a first timing advance (TA) command to start or restart the first TAT at the UE and a second timing advance command to start or restart the second TAT at the UE.

In a forty fifth example, the base station of the twenty eighth example, wherein the OOS condition is detected when the first TAT expires or when the first TAT has not started.

In a forty sixth example, a processor of a base station configured with a first transmission and reception point (TRP) and a second TRP in a multi-TRP network arrangement, wherein the processor of the base station is configured to transmit, to a user equipment (UE), an uplink (UL) timing advance configuration including a single time alignment timer (TAT) corresponding to the first TRP and a second TAT corresponding to the second TRP, detect an out of synchronization (OOS) condition for either the first TRP or the second TRP and in response to detecting the OOS condition, transmit a physical downlink control channel (PDCCH) order triggering at least one UE physical random access channel (PRACH) transmission.

In a forty seventh example, the processor of forty sixth example, wherein a single UE PRACH transmission is received at either the first TRP or the second TRP.

In a forty eighth example, the processor of forty sixth example, wherein a respective UE PRACH transmission is received at both the first and second TRPs.

In a forty ninth example, a base station comprises a first transmission and reception point (TRP), a second TRP in a multi-TRP network arrangement, and a processor communicatively coupled to the first TRP and the second TRP wherein the processor is configured to transmit, to a user equipment (UE), an uplink (UL) timing advance configuration including a single time alignment timer (TAT) corresponding to the first TRP and a second TAT corresponding to the second TRP, detect an out of synchronization (OOS) condition for either the first TRP or the second TRP and in response to detecting the OOS condition, transmit a physical downlink control channel (PDCCH) order triggering at least one UE physical random access channel (PRACH) transmission.

In a fiftieth example, the base station of forty ninth example, wherein a single UE PRACH transmission is received at either the first TRP or the second TRP.

In a fifty first example, the base station of forty ninth example, wherein a respective UE PRACH transmission is received at both the first and second TRPs.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as ios, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to:
process, based on signaling received from a serving base station of a radio access network, an uplink (UL) timing advance configuration including a first time alignment timer (TAT) corresponding to a first transmission and reception point (TRP) and a second TAT corresponding to a second TRP in a multi-TRP network arrangement;
detect an out of synchronization (OOS) condition for the first TRP based on the first TAT while the second TRP remains synchronized based on the second TAT, or receive a physical downlink control channel (PDCCH) order from the network mapped to the first TRP triggering a physical random access channel (PRACH) transmission;
stop UL transmissions for at least the first TRP; and
generate, for transmission to the network, the PRACH so that the network can determine and configure a new TAT for the first TRP.

2. The processor of claim 1, wherein the first TRP is assigned to a first timing advance group (TAG) and the second TRP is assigned to a second TAG, wherein the first TAT is maintained for the first TAG and the second TAT is maintained for the second TAG.

3. The processor of claim 2, wherein the UE detects the OOS condition for the first TRP and transmits the PRACH to the first TRP only.

4. The processor of claim 1, wherein the first TRP and the second TRP are assigned to a same timing advance group (TAG) and the first and second TATs are maintained in the same TAG.

5. The processor of claim 4, wherein the timing advance configuration indicates a parameter mapping a given TAT to the first TRP or the second TRP within the same TAG.

6. The processor of claim 5, wherein the parameter comprises a closed loop power control index or a CORESETPoolIndex.

7. The processor of claim 1, wherein, when the OOS condition is detected or indicated for the first TRP, the UE stops the UL transmissions for the first TRP until the new TAT is received and continues UL transmissions for the second TRP.

8-9. (canceled)

10. The processor of claim 1, wherein, when the OOS condition is detected or indicated for the first TRP, the UE stops the UL transmissions for both the first TRP and the second TRP until the new TAT is received for the first TRP and a further new TAT is received for the second TRP.

11. The processor of claim 1, wherein the UE receives the PDCCH order including a parameter mapping to the first TRP to trigger the PRACH transmission to the first TRP.

12. (canceled)

13. The processor of claim 1, wherein the UE receives the PDCCH order including a parameter mapping to both the first TRP and the second TRP to trigger a first PRACH transmission to the first TRP and a second PRACH transmission to the second TRP.

14. (canceled)

15. The processor of claim 1, wherein the UE receives the PDCCH order including a parameter mapping to either the first TRP, the second TRP, or both the first TRP and the second TRP to trigger the PRACH transmission to the first TRP, the second TRP, or both the first TRP and the second TRP.

16. (canceled)

17. The processor of claim 1, wherein the processor of the UE is further configured to:
process a first timing advance (TA) command to start or restart the first TAT and a second timing advance command to start or restart the second TAT.

18. The processor of claim 1, wherein the OOS condition is detected when the first TAT expires or when the first TAT has not started.

19. The processor of claim 1, wherein the processor of the UE is further configured to:
determine that a first UL transmission to the first TRP and a second UL transmission to the second TRP overlap at least partially in time; and
drop the first UL transmission or the second UL transmission.

20. The processor of claim 1, wherein the processor of the UE is further configured to:
determine that a first downlink (DL) reception from the first TRP and a second DL reception from the second TRP have a reception timing difference exceeding a maximum reception timing difference; and
report the reception timing difference to the network.

21. (canceled)

22. A processor of a base station configured with a first transmission and reception point (TRP) and a second TRP in a multi-TRP network arrangement, wherein the processor is configured to:
generate, for transmission to a user equipment (UE), an uplink (UL) timing advance configuration including a first time alignment timer (TAT) corresponding to the first TRP and a second TAT corresponding to the second TRP;
detect an out of synchronization (OOS) condition for the first TRP while the second TRP remains synchronized;
in response to detecting the OOS condition, generate a physical downlink control channel (PDCCH) order, mapped to the first TRP, that triggers a UE physical random access channel (PRACH) transmission;
process the UE PRACH transmission;
determine a new timing advance (TA) based on a time delay from the UE PRACH transmission; and
generate, for transmission to the UE, a new timing advance configuration including the new TA.

23. The processor of claim 22, wherein the first TRP is assigned to a first timing advance group (TAG) and the second TRP is assigned to a second TAG, wherein the first TAT is maintained for the first TAG and the second TAT is maintained for the second TAG.

24. (canceled)

25. The processor of claim 22, wherein the first TRP and the second TRP are assigned to a same timing advance group (TAG) and the first and second TATs are maintained in the same TAG.

26-27. (canceled)

28. The processor of claim 22, wherein the processor of the base station is further configured to:
receive the UL transmissions for the second TRP while the first TRP is OOS with the UE when the UL transmissions for the first TRP are stopped until the new TAT is received.

29-30. (canceled)

31. The processor of claim 22, wherein, when the OOS condition is detected or indicated for the first TRP, the UL transmissions are stopped for both the first TRP and the second TRP until the new TAT is received for the first TRP and a further new TAT is received for the second TRP.

32-39. (canceled)
